(19) United States
(12) Patent Application Publication
(10) Pub. No.: US 2022/0029143 A1
(43) Pub. Date: Jan. 27, 2022

(54) METHOD FOR PRODUCING A POSITIVE ELECTRODE FOR A BATTERY CELL

(71) Applicant: Robert Bosch GmbH, Stuttgart (DE)

(72) Inventors: Joo Young Choi, Braunschweig (DE); Younggeun Choi, Moeglingen (DE)

(21) Appl. No.: 17/294,059

(22) PCT Filed: Nov. 11, 2019
(86) PCT No.: PCT/EP2019/080854

§ 371 Date: May 14, 2021

(30) Foreign Application Priority Data
Nov. 15, 2018 (DE) 10 2018 219 472.6

(51) Int. Cl. H01M 4/04; H01M 4/62

(52) U.S. Cl. CPC H01M 4/0416; H01M 4/625; H01M 2004/028; H01M 2220/20; H01M 4/623

(57) ABSTRACT

The invention describes a method (10) for producing a positive electrode for a battery cell, comprising an active material and a conductive additive, wherein the active material has a first number of, in particular spherical, active material particles with a first mean diameter, and wherein the conductive additive has a second number of, in particular spherical, conductive additive particles with a second mean diameter, wherein the active material and the conductive additive are provided in a first method step (102), wherein the number of conductive additive particles is adjusted depending on a ratio of the second mean diameter to the first mean diameter and on the number of active material particles.

### BACKGROUND

The present invention relates to a method.

Because of their high energy density and their good thermal stability, secondary batteries, preferably lithium ion batteries, are suitable for the storage of electrical energy in various application fields, above all in electrically powered vehicles.

Lithium ion batteries comprise one or more lithium ion battery cells. Such lithium ion battery cells conventionally contain one or more electrode units in the form of electrode windings or electrode stacks, which have at least one positive electrode, at least one negative electrode and at least one ion-conducting separator that spatially separates the positive and negative electrodes from one another. The positive and negative electrodes are respectively located at a positive and negative current collector. When forming a lithium ion battery cell, the electrode units are accommodated in a housing, which may be prismatic, round or foil-like, depending on the application.

The properties characterizing the lithium ion battery cells, such as electrical conductivity, power density and energy density, are primarily dependent on the design and material properties as well as the production process of the positive electrode.

In this regard, a method for producing a positive electrode, in which a mixture of an active material having a multiplicity of active material particles and a conductive additive is provided in a first method step, is known from US 2017/8468 A1. The active material particles preferably have a mean diameter of from 10 to 50 nm.

A further method for producing a positive electrode for a lithium ion battery cell, in which a mixture of active material and a conductive additive is provided in a first method step, the active material preferably having larger particles than the conductive additive, is known from US 2017/098817 A1.

### SUMMARY

According to the invention, a method for producing a positive electrode for a battery cell is provided, the positive electrode comprising an active material and a conductive additive.

The active material contains a first number of active material particles, in particular spherical active material particles, which have a first mean diameter. A second number of conductive additive particles, in particular spherical conductive additive particles, is at the same time provided. The conductive additive particles have a second mean diameter. Active material refers to those material components of an electrode at which the corresponding electrochemical processes, for example the intercalation or deintercalation of lithium ions, take place during operation of the battery cell.

The conductive additive is used to increase the electrical conductivity in the positive electrode and to electrically connect individual active material particles to one another.

In a first method step, the active material and the conductive additive are provided, the number of conductive additive particles being adjusted according to a ratio of the second mean diameter to the first mean diameter and the number of active material particles.

In this case, it is advantageous that a surface of the active material particles is coated surface-wide with conductive additive material particles. As a result of the above-described setting of the number of conductive additive particles, the surface of the active material particles is covered substantially fully by the conductive additive particles provided. The total electrical resistance of the battery cell, comprising an ohmic resistance, a charge transfer resistance and a diffusion resistance, is thus reduced significantly in comparison with conventional battery cells.

The dependent claims relate to further advantageous embodiments of the present invention.

Thus, it is advantageous for conductive additive particles to be dispersed in a binder in a second method step.

It is furthermore advantageous for an initial weight of the binder to be adjusted in the second method step to be equal to an initial weight of the conductive additive particles provided in the first method step.

It is furthermore advantageous for the dispersion of the binder and the conductive additive particles to be mixed in a third method step with the active material particles that are provided in the first method step.

In order to reduce the diffusion resistance which is caused by movement of the lithium ions between a positive and negative electrode in a battery cell, preferably in a lithium ion battery cell, a further quantity of binder is mixed with a further quantity of conductive additive particles in a fourth method step. The total quantity of conductive additive particles in the positive electrode is preferably from 4% to 10% in relation to the total quantity of active material particles. The total quantity of conductive additive particles is made up of a quantity according to the first method step and a further quantity according to the third method step.

In a fifth method step, the mixture comprising binder and conductive additive particles from the fourth method step is mixed with the mixture from the third method step.

It is in this case advantageous for a solvent to be added in a sixth method step to the mixture according to the fifth method step, in order to be able to suspend all the solids, in particular the binder. The solvent may be N-methyl-2-pyrrolidone (NMP).

When forming a positive electrode layer, the suspension according to the sixth method step is applied on a carrier foil in a seventh method step. The carrier foil preferably comprises an aluminum foil, which also functions as a positive current collector. After the application of the suspension on the carrier foil, the solvent is finally evaporated, for example in an autoclave.

The method according to the invention may advantageously be used for positive electrodes in lithium ion battery cells that are employed in electrical vehicles, in hybrid vehicles, or in static applications, for example for the storage of regeneratively obtained energy.

### BRIEF DESCRIPTION OF THE DRAWINGS

Advantageous embodiments of the present invention are represented in the drawing and explained in more detail in the following description of the figures.

FIG. 1: shows a schematic representation of a method according to the invention for producing a positive electrode for a battery cell,

FIG. 2: shows a schematic sectional view of a positive electrode according to the invention for a battery cell.

### DETAILED DESCRIPTION

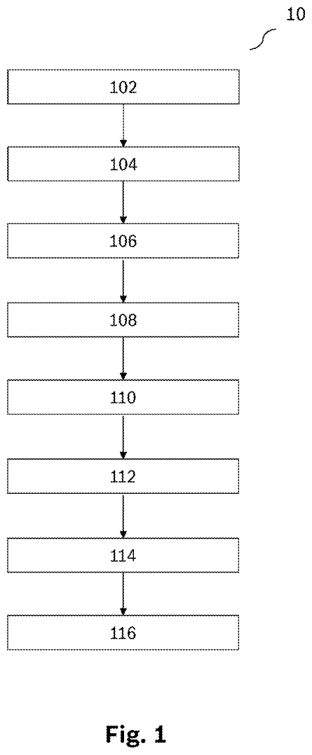

FIG. 1 schematically represents a method 10 according to the invention for producing a positive electrode for a battery cell, preferably a lithium ion battery cell. The method 10 may, for example, be carried out in the order represented.

In a first method step 102, an active material and a conductive additive are provided. Preferably, the active material may be a lithium metal oxide, a lithium iron phosphate or a lithium titanate oxide, and the conductive additive may comprise carbon black.

The active material has a first number n₁ of active material particles, in particular spherical active material particles. Furthermore, the conductive additive has a second number n₂ of conductive additive particles, in particular spherical conductive additive particles. There is a first mean diameter D̅₁ of the in particular spherical active material particles and a second mean diameter D̅₂ of the in particular spherical conductive additive particles. In the first method step, the number of conductive additive particles to be used is adjusted according to a ratio of the second mean diameter D̅₂ of the conductive additive particles to the first mean diameter D̅₁ of the active material particles and the number of active material particles provided. The adjustment may be mathematically described by the following formula:

$${n}_{2} = N * \frac{{\overline{D}}_{2}}{{\overline{D}}_{1}} * {n}_{1} ,$$

where N stands for a number in a range of 1.6 and 1.7. Preferably, N is equal to 1.64.

In a second method step 104, the conductive additive particles according to the first method step are dispersed in a binder. The binder may for example comprise a polymer, preferably polyvinylidene fluoride (PVDF). An initial weight of the binder is in this case adjusted in such a way that the initial weight of the binder is equal to an initial weight of the conductive additive particles.

Next, the dispersion is mixed in a third method step 106 with the active material particles which are provided according to the first method step 102.

In a fourth method step 108, a further quantity of binder is then mixed with a further quantity of conductive additive particles.

Subsequently, in a fifth method step 110, the mixture of the further quantity of binder and the further quantity of conductive additive particles is combined with the mixture according to the third method step 106.

Next, in a sixth method step 112, the mixture according to the fifth method step 110 is suspended in a solvent, preferably N-methyl-2-pyrrolidone (NMP). This suspension is applied on a carrier foil in a seventh method step 114. This carrier foil may be an aluminum foil, which also functions as a positive current collector for the positive electrode.

Finally, in an eighth method step 116, the solvent of the suspension is evaporated. This process may preferably be carried out in an autoclave at a temperature of from 140° C. to 160° C.

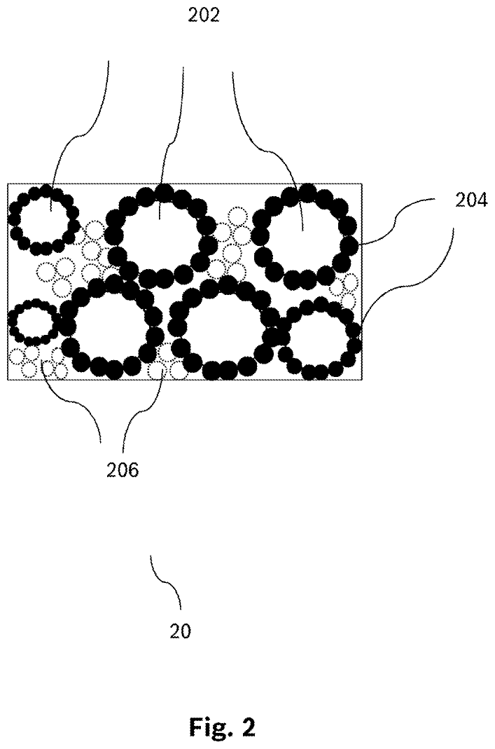

FIG. 2 schematically represents a sectional view of a positive electrode 20 which is produced according to the method 10 described above in the form of a positive electrode layer. The positive electrode 20 comprises at least a number of, in particular, spherical active material particles 202 and a mixture 204 of, in particular, spherical conductive additive material particles and an initial weight of binder. The surfaces of the in particular spherical active material particles 202 are in this case covered with the mixture 204. Furthermore, a further mixture 206 of a further quantity of, in particular, spherical conductive additive material particles and a further quantity of binder is provided in the intermediate spaces between the in particular spherical active material particles 202 covered with the mixture 204. The in particular spherical active material particles 202 may be different sizes.

Such positive electrodes 20 may advantageously be used for battery cells that are employed in motor vehicles, particularly in electric vehicles (EV), hybrid (electric) vehicles (HEV) and plug-in hybrid (electric) vehicles (PHEV).

1. A method for producing a positive electrode for a battery cell, having an active material and a conductive additive,
wherein the active material has a first number of active material particles with a first mean diameter,
and wherein
the conductive additive has a second number of conductive additive particles with a second mean diameter,
characterized in that
the active material and the conductive additive are provided in a first method step (102), the number of conductive additive particles being adjusted according to a ratio of the second mean diameter to the first mean diameter and the number of active material particles.

2. The method as claimed in claim 1,
wherein the positive electrode furthermore comprises a binder,
characterized in that
conductive additive particles are dispersed in the binder in a second method step (104).

3. The method as claimed in claim 2,
characterized in that
an initial weight of the binder is adjusted in the second method step (104) so that the initial weight of the binder is equal to an initial weight of the conductive additive particles.

4. The method as claimed in claim 3,
characterized in that
the dispersion from the second method step (104) is mixed in a third method step (106) with the active material particles provided in the first method step (102).

5. The method as claimed in claim 4,
characterized in that
a further quantity of binder is mixed with a further quantity of conductive additive particles in a fourth method step (108).

6. The method as claimed in claim 5,
characterized in that
the mixture from the fourth method step (108) is mixed in a fifth method step (110) with the mixture from the third method step (106).

7. The method as claimed in claim 6,
characterized in that
the mixture from the fifth method step (110) is suspended in a solvent in a sixth method step (112).

8. The method as claimed in claim 7,
characterized in that
the suspension is applied on a carrier foil in a seventh method step (114).

9. The method as claimed in claim 8,
characterized in that
the solvent is finally evaporated from the suspension in an eighth method step (116).

10. The method as claimed in claim 1, characterized in that the active material particles and the conductive additive particles are spherical.

11. The method as claimed in claim 7, characterized in that the solvent is N-methyl-2-pyrrolidone (NMP).

12. The method as claimed in claim 8, characterized in that the carrier foil is made of aluminum.
